(19) United States
(12) Patent Application Publication
(10) Pub. No.: US 2021/0229609 A1
(43) Pub. Date: Jul. 29, 2021

(54) ISOLATION FOR WORK MACHINE ELECTRICAL CONNECTORS

(71) Applicant: Caterpillar Paving Products Inc., Brooklyn Park, MN (US)

(72) Inventor: Steven P. Goutermont, Saint Michael, MN (US)

(73) Assignee: Caterpillar Paving Products Inc., Brooklyn Park, MN (US)

(21) Appl. No.: 16/773,279

(22) Filed: Jan. 27, 2020

(51) Int. Cl. B60R 16/03; E01C 19/42; E01C 23/088

(52) U.S. Cl. CPC B60R 16/03; E01C 19/4873; E01C 23/088; E01C 19/42

(57) ABSTRACT

A work machine includes a power source, a plurality of connectors, and an isolator circuit. The power source is configured to provide power to an electrical system of the work machine. The plurality of connectors are for electrically connecting external components to the work machine and are configured to receive power from the power source. The isolator circuit is connected between at least one of the plurality of connectors and the electrical system of the work machine to selectively terminate power to the at least one of the plurality of connectors while the power source is providing power to the electrical system of the work machine.

### TECHNICAL FIELD

The present application relates generally to electrical systems. More particularly, the present application relates to electrical isolation for electrical components of work machines.

### BACKGROUND

Paving machines are used to grind out, apply, spread and compact paving material relatively evenly over a desired surface. These machines are regularly used in the construction of roads, parking lots and other areas where a smooth durable surface is required for cars, trucks and other vehicles to travel. When a crew arrives at a paving machine and/or cold planer, the crew often starts the machine to warm up the cold planer, the paver, and a screed. While the machines are warming up, external components may be plugged in and/or swapped out for use during operation of the machine.

WO 2011135846 A1 discusses an electrical system for an asphalt finisher that includes a changeover switch for changing between primary power of the asphalt finisher and a secondary, external, power source.

### SUMMARY OF THE INVENTION

In one example, a work machine includes a power source, a plurality of connectors, and an isolator circuit. The power source is configured to provide power to an electrical system of the work machine. The plurality of connectors are for electrically connecting external components to the work machine and are configured to receive power from the power source. The isolator circuit is connected between at least one of the plurality of connectors and the electrical system of the work machine to selectively terminate power to the at least one of the plurality of connectors while the power source is providing power to the electrical system of the work machine.

In another example, a method of electrical isolation for a work machine includes powering, via a power source, an electrical system of the work machine; controlling an isolator circuit to terminate power to at least one of a plurality of connectors from the electrical system of the work machine; changing a connected state of at least one component with respect to the at least one of the plurality of connectors; and controlling the isolator circuit to reconnect power to the at least one of the plurality of connectors from the electrical system.

In another example, an electrical system of a work machine includes a machine electrical system, a plurality of connectors, and an isolator circuit. The machine electrical system is connected to receive power from a power source of the work machine. The plurality of connectors are for electrically connecting and disconnecting detachable components to the work machine and are configured to receive power from the machine electrical system. The isolator circuit is connected between at least one of the plurality of connectors and the machine electrical system to selectively terminate power to the at least one of the plurality of connectors while the power source is providing power to the machine electrical system.

### BRIEF DESCRIPTION OF THE DRAWINGS

FIGS. 1A-1C are block diagrams illustrating paving machines having example electrical systems that include isolator circuits.

FIG. 2 is a block diagram illustrating a cold planer having an example electrical system that includes an isolator circuit.

FIG. 3 is a flowchart illustrating an example method of isolating electrical components for a work machine

FIG. 4 is a flowchart illustrating another example method of isolating electrical components for a work machine.

### DETAILED DESCRIPTION

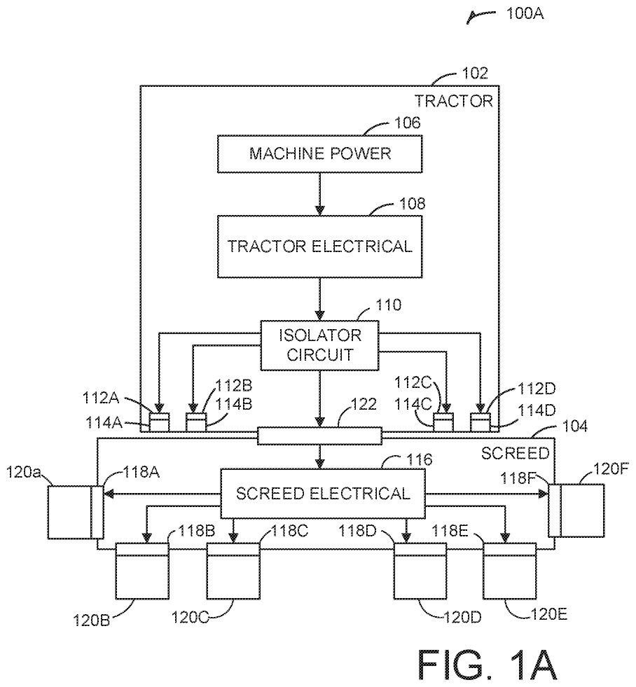

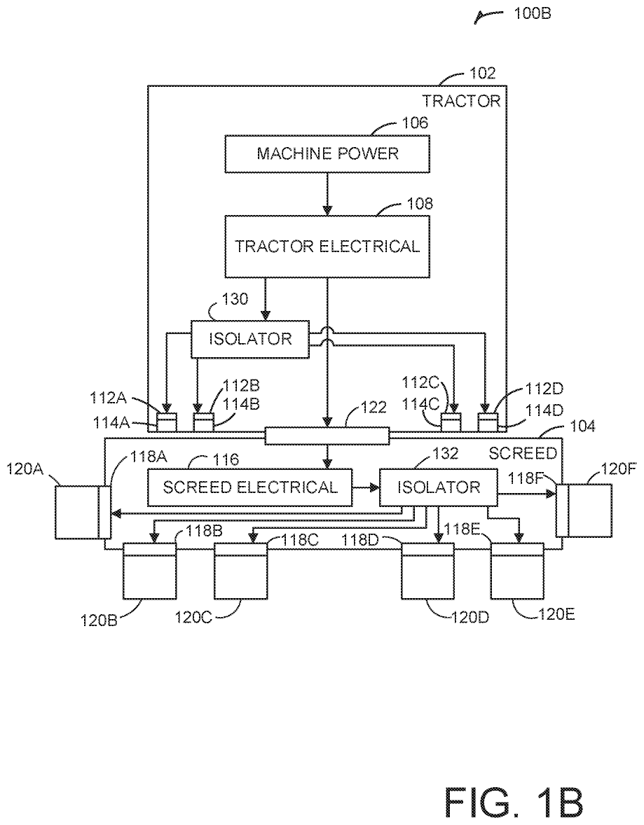

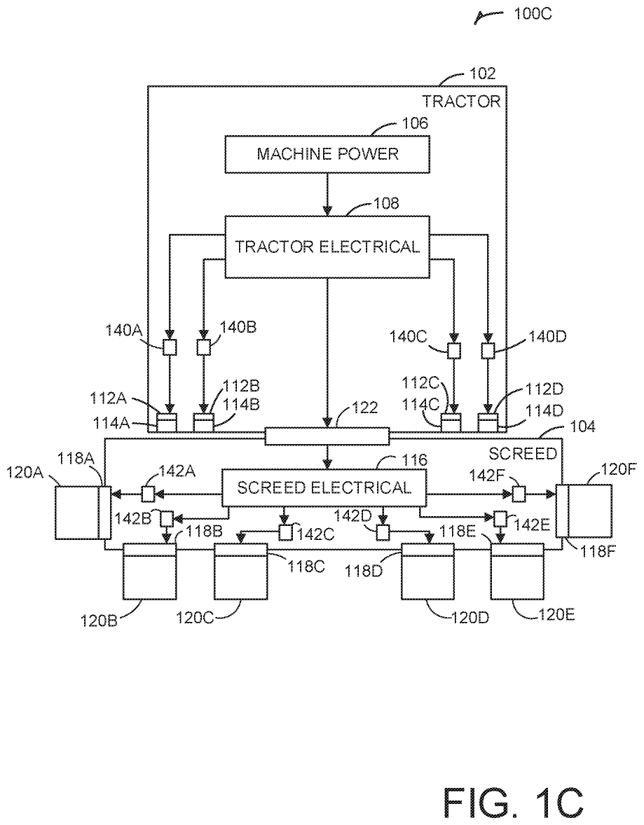

FIGS. 1A-1C are block diagrams illustrating work machines, specifically paving machines 100A-100C, having electrical systems that include one or more isolator circuits. While described below with respect to paving machines, also known as pavers, and cold planer machines, any other work machines, including compactors, mixers, scrapers, dozers, excavators, material haulers, and other example machine types may include the systems and methods described herein.

FIG. 1A is a block diagram illustrating an example electrical system for a paving machine 100A. The paving machine 100A includes at least a tractor 102 and a screed 104. The paving machine 100A can include any additional components not illustrated in FIG. 1A. The tractor 102 includes machine power 106, tractor electrical system 108, an isolator circuit 110, connectors 112A-112D, and external components 114A-114D. The screed 104 includes screed electrical system 116, connectors 118A-118F, and external components 120A-120F. The screed electrical system 116 is connected to the isolator circuit 110 through an electrical connector 122, such as a wiring harness, for example,

The paving machine 100A may be used to spread and compact paving material relatively evenly over a desired surface. The paving machine may include a hopper, for example, for receiving asphalt material from a truck and a conveyor system for transferring the asphalt rearwardly from the hopper for discharge onto a roadbed. Screw augers may be used to spread the asphalt transversely across the roadbed in front of a screed plate. The screed plate smooths and somewhat compacts the asphalt material to leave a roadbed of uniform depth and smoothness.

The machine power 106 may be generated using one or more power sources such as a prime mover of the paving machine 100A, one or more backup power sources, and/or one or more external power sources. For example, the paving machine 100A may include an internal combustion engine, such as a diesel engine, an electric motor powered by a battery pack, or another engine type. In an example, in internal combustion engine may include one or more attached generators configured to convert mechanical energy from the engine into electrical energy for use by the paver electrical systems. In other examples, the machine power 106 may be received from one more backup power sources including batteries, capacitors, external power sources, and the like in addition to, or in place of, the primary power source.

The tractor electrical system 108 may encompass the electrical wiring and/or other electrical components of the tractor 102 to distribute electrical power from the machine power 106 to the isolator circuit 110 and other machine electrical components. For example, the paving machine 100A may include one or more control systems that include controllers, processors, and/or other components that receive and use electrical power. In one example, a single wire or wire harness may be used to carry electrical power from the machine power 106 to the isolator circuit 110. In conventional paving systems, the tractor electrical system 108 distributes power from the machine power 106 directly to the plurality of connectors 112A-112D. The screed electrical system 116 may encompass the electrical wiring and/or other electrical components of the screed 104 to distribute electrical power received through the electrical connector 122.

In conventional paver machines, power is received by the connectors 112A-112D and 118A-118F any time the engine of the paving machine is running and the tractor electrical system 108 is receiving power. When a crew arrives at a paving machine, it is desirable to start the engine to warm up the paving machine and also warm up the screed. While the machine is warming up, the crew plugs in and/or unplugs the components 114A-114D from the connectors 112A-112D. In conventional systems, because the engine is running and the machine is warming up, power is being provided to the connectors 112A-112D and 118A-118F.

The components 114A-114D and 120A-120F may be sensors, controls, and the like. For example, the tractor components 114A-114D may include left and right auger height sensors, left and right conveyor height sensors, and the like. The components 120A-120F may include left and right material height sensors, left and right grade sensors, pendant controls, and the like. The components 114A-114D and 120A-120F may also include any other sensors, controls, or other electrical components capable of connecting to the tractor 102 and/or the screed 104 through the connectors 112A-112D and/or 118A-118F.

The connectors 112A-112D and 118A-118F may be configured in any way to provide electrical power to the components 114A-114D and 120A-120F. In an example, the connectors may be male- or female-type connectors, and may include any number of pins or other electrical connections including, for example, a power connection and a ground connection. When plugging components into the connectors 112A-112D and 118A-118F, if the power line is hot, arcing may occur, which can cause damage to the component, the connector, and/or blow fuses of the electrical system of the tractor 102 or screed 104.

The isolator circuit 110 is configured to disconnect and isolate the connectors 112A-112D and 118A-118F from the machine power 106. The isolator circuit 110 may include one or more isolator switches which may be mechanical, electrical, or electro-mechanical, in an example, a single isolator switch may be used to provide isolation for all connectors 112A-112D and 118A-118F. The isolator switch(es) may be manually operable such that an operator of the paving machine 100A may manually terminate power to the connectors 112A-112D and 118A-118F when connecting/disconnecting any of the components 114A-114D and/or 120A-120F and then manually reconnect power to the connectors 112-112D and 118A-118F. This way, the machine power 106 can remain on, allowing connection/disconnection of components 114A-114D and 120A-120F while the paving machine 100A is warming up. In other examples, the isolator circuit 110 may be controllable through one or more electronic control inputs. For example, an input/output (IO) device located on the paving machine 100A, such as at an operator control station, may receive input from an operator to control a state of a respective switch of the isolation circuit 110.

FIGS. 1B and 1C illustrate additional example paving machines 100B and 100C, respectively. Instead of the isolator circuit 110 illustrated in FIG. 1A, the paving machine 100B includes separate isolator circuits 130 and 132. The isolator circuit 130 is connected between the tractor electrical system 108 and the connectors 112A-112D and the isolator circuit 132 is connected between the screed electrical system 116 and the connectors 118A-118F. Each isolator circuit 130 and 132 may include one or more mechanical or electrical switches, for example, manually or electronically controllable to selectively connect and terminate power to and from the tractor electrical system 108 and the screed electrical system 116, respectively.

The isolator circuit 130 may be physically positioned on the tractor 102 and the isolator circuit 132 may be physically positioned on the screed 104, for example. This way, if an operator of the paving machine 100B wishes to only connect/disconnect one of the components 120A-120F, the operator can control the isolator circuit 132, which may be positioned on the screed 104, near the connectors 118A-118F, rather than needing to control an isolator circuit positioned physically on the tractor 102. While illustrated as connected between the screed electrical system 116 and the connectors 118A-118F, the isolator circuit 132 may also be connected between the electrical connector 122 and the screed electrical system 116, for example.

The paving machine 1000, as illustrated in FIG. 1C, includes isolator circuits 140A-140D and 142A-142F. While illustrated as having a 1:1 relationship with the connectors 112A-112D and 118A-118F, the paving machine 100C may include any number of isolator circuits 140A-140D and 142A-142F. The isolator circuits 140A-140D and 142A-142F may each include one or more electrical or mechanical switches configured to selectively terminate power to the connectors 112A-112D and 118A-118F from the tractor electrical system 108 and the screed electrical system 116, respectively. Each isolator circuit 140A-140D and 142A-142F may be positioned on the tractor 102 or screed 104 in a position relatively close to a respective connector 112A-112D and 118A-118F. This way, an operator that wishes to connect or disconnect a specific component 114A-114D or 120A-120F can quickly and easily locate the isolator circuit for the respective component.

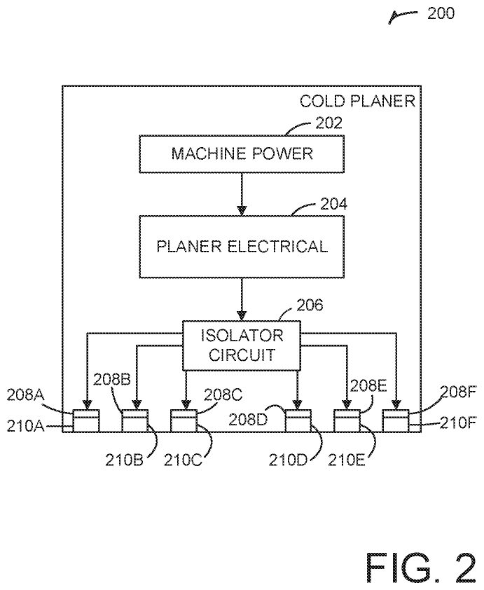

FIG. 2 is a block diagram illustrating an example electrical system for a cold planer machine 200. The cold planer machine 200, also referred to as a milling machine, includes machine power 202, planer electrical system 204, an isolator circuit 206, connectors 2084-208F, and external components 210A-210F. The cold planer machine 200 may be used to process paving material, such as by scarifying, removing, or reclaiming such material from the surface of a paved road. These machines can include a frame having a rotary cutting tool for processing the paving material, and two or more tracks or wheel units for propelling the cold planer machine 200 forward. The two or more tracks or wheel units can be coupled to the frame of the cold planer machine 200 using extendable struts that can be adjusted (e.g., extended or retracted) to raise or lower the frame of the cold planer machine 200, such as to control the depth at which the cold planer machine 200 cuts into a surface or road.

The machine power 202 may be generated using one or more power sources such as a prime mover of the cold planer machine 200, one or more backup power sources, and/or one or more external power sources. For example, the cold planer machine may include an internal combustion engine, such as a diesel engine, an electric motor powered by a battery pack, or another engine type. The planer electrical system 204 may encompass the electrical wiring and/or other electrical components of the cold planer machine 200 to distribute electrical power from the machine power 202 to the isolator circuit 206 and other machine electrical components. In one example, a single wire or wire harness may be used to carry electrical power from the machine power 202 to the isolator circuit 206.

In conventional cold planer machines, power is received by the connectors 208A-208F any time the engine is running and the planer electrical system 204 is receiving power. When a crew arrives at a cold planer machine, it is desirable to start the engine to warm up the cold planer machine. While the machine is warming up, the crew plugs in and/or unplugs the components 210A-210F from the connectors 208A-208F. in conventional systems, because the engine is running and the machine is warming up, power is being provided to the connectors 208A-208F.

The components 210A-210F may be sensors, controls, and the like. For example, the components 210A-210F may include grade sensors, pendant controls, and the like. The connectors 208A-208F may be configured in any way to provide electrical power to the components 210A-210F. In an example, the connectors may be male- or female-type connectors and may include any number of pins or other electrical connections including, for example, a power connection and a ground connection. When plugging components into the connectors 208A-208F, if the power line is hot, arcing may occur, which can cause damage to the component, the connector, and/or blow fuses of the electrical system of the cold planer machine 200.

The isolator circuit 206 is configured to disconnect and isolate the connectors 208A-208F from the machine power 202. The isolator circuit 206 may include one or more isolator switches which may be mechanical, electrical, or electro-mechanical. In an example, a single isolator switch may be used to provide isolation for all connectors 208A-208F, The isolator switch(es) may be manually operable such that an operator of the cold planer machine 200 may manually terminate power to the connectors 208A-208F when connecting/disconnecting any of the components 210A-210F and then manually reconnect power to the connectors 208A-208F. This way, the machine power 202 can remain on, allowing connection/disconnection of components 210A-210F while the cold planer machine 200 is warming up. In another example, several separate isolator switches may be connected between each connector 2084-208F and the planer electrical system 204.

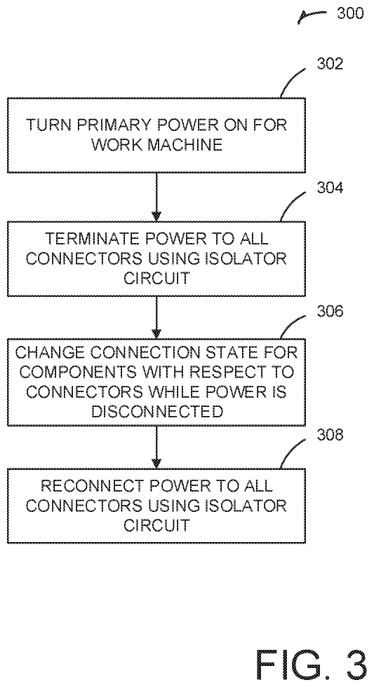

FIG. 3 is a flowchart illustrating an example method 300 of isolating electrical components for a work machine. At step 302, power is turned on for the work machine. This may be accomplished by starting an engine of the work machine, for example. Electrical energy may be generated using the mechanical energy generated by the engine and provided to an electrical system of the work machine. At step 304, an isolator circuit, such as the isolator circuit 110, is controlled to terminate power to all electrical connectors of the work machine that allow connection or disconnection of external components, such as external sensors, controls, and the like. In an example, the work machine may be a paving machine and include connectors on both a tractor portion of the paving machine and a screed portion. Power may be terminated to connectors on both portions of the paving machine. In another example, the work machine may be a cold planer machine.

At step 306, while power is terminated to the connectors, an operator of the work machine changes the connection state of at least one of the external components with respect to the connectors. This may include connecting a component to the work machine and/or disconnecting a component from the work machine. By changing the connection state while power is disconnected from the connectors, the risk of damage to the components and/or the work machine electrical system is reduced. At step 308, following connection or disconnection of the components, the isolator circuit is controlled to reconnect power to all connectors of the work machine from the machine electrical system.

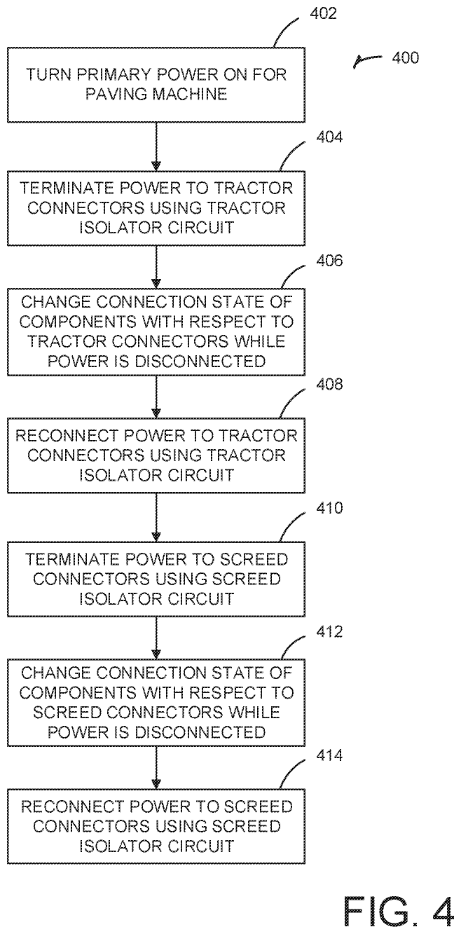

FIG. 4 is a flowchart illustrating another example method 400 of isolating electrical components for a paving machine that includes a tractor portion and a screed portion. At step 402, power is turned on for the paving machine. This may be accomplished by starting an engine of the paving machine, for example. Electrical energy may be generated using the mechanical energy generated by the engine and provided to an electrical system of the work machine. At step 404, an isolator circuit, such as the isolator circuit 130, is controlled to terminate power to electrical connectors of the tractor portion of the paving machine that allow connection or disconnection of external components, such as external sensors, controls, and the like.

At step 406, while power is terminated to the connectors of the tractor portion, an operator of the paving machine changes the connection state of at least one of the external components with respect to the tractor connectors. This may include connecting a component to the tractor and/or disconnecting a component from the tractor. By changing the connection state while power is disconnected from the connectors, the risk of damage to the components and/or the tractor electrical system is reduced. At step 408, following connection or disconnection of the components, the isolator circuit 130 is controlled to reconnect power to all connectors of the tractor portion from the tractor electrical system,

At step 410, an isolator circuit, such as the isolator circuit 132, is controlled to terminate power to electrical connectors of the screed portion of the paving machine that allow connection or disconnection of external components, such as external sensors, controls, and the like. At step 412, while power is terminated to the connectors of the screed portion, an operator of the paving machine changes the connection state of at least one of the external components with respect to the screed connectors. This may include connecting a component to the screed and/or disconnecting a component from the screed. By changing the connection state while power is disconnected from the connectors, the risk of damage to the components and/or the screed electrical system is reduced. At step 414, following connection or disconnection of the components, the isolator circuit 132 is controlled to reconnect power to all connectors of the screed portion from the screed electrical system.

### INDUSTRIAL APPLICABILITY

In one illustrative example, a paving machine, such as a Caterpillar AP355F Paver, includes several external components that can be plugged into/unplugged from the paver and/or screed. For example, left and right auger height sensors and left and right conveyor height sensors can be plugged into the tractor of the paver. Left and right material height sensors, two grade sensors, and two pendant controls can be plugged into a screed connected to the paver. When a crew arrives at the paver, the crew may start the engine to warm up the paver and also warm up the screed heater. During this time, the crew plugs in and/or unplugs external devices as desired. Prior to performing these actions, one or more isolation circuits are controlled to terminate power from the paver electrical system to the connectors for the external devices. Once the power is terminated to the connectors, the external devices are plugged in or unplugged. Following connection/disconnection of the external devices, the isolation circuits are controlled to resupply power to the external components for use during operation of the paver.

The above detailed description is intended to be illustrative, and not restrictive. The scope of the disclosure should, therefore, be determined with references to the appended claims, along with the full scope of equivalents to which such claims are entitled.

What is claimed is:

1. A work machine comprising:
a power source configured to provide power to an electrical system of the work machine:
a plurality of connectors for electrically connecting external components to the work machine, the plurality of connectors configured to receive power from the power source; and
an isolator circuit connected between at least one of the plurality of connectors and the electrical system of the work machine to selectively terminate power to the at least one of the plurality of connectors while the power source is providing power to the electrical system of the work machine.

2. The work machine of claim 1, wherein the work machine is a paving machine, and wherein the work machine further comprises:
a tractor portion, wherein the power source is positioned on the tractor portion, and wherein the plurality of connectors comprise a first plurality of connectors positioned on the tractor portion.

3. The work machine of claim 2, further comprising:
a screed portion, wherein the plurality of connectors further comprise a second plurality of connectors positioned on the screed portion.

4. The work machine of claim 3, wherein the isolator circuit is a first isolator circuit and the at least one of the plurality of connectors is at least one of the first plurality of connectors, and wherein the work machine further comprises:
a second isolator circuit connected between the electrical system and at least one of the second plurality of connectors.

5. The work machine of claim 3, wherein the external components comprise first components connectable to the first plurality of connectors and second components connectable to the second plurality of connectors, and wherein the first components comprise at least one of an auger height sensor or a conveyor height sensor, and wherein the second components comprise at least one of a grade sensor, a height sensor, or a pendant control.

6. The work machine of claim 1, wherein the work machine is a cold planer machine, and wherein the external components comprise at least one of a grade sensor or a pendant control.

7. The work machine of claim 1, wherein the isolator circuit comprises a plurality of isolator circuits, each connected between a respective one of the plurality of connectors and the machine electrical system.

8. A method of electrical isolation for a work machine, the method comprising:
powering, via a power source, an electrical system of the work machine;
controlling an isolator circuit to terminate power to at least one of a plurality of connectors from the electrical system of the work machine;
changing a connected state of at least one component with respect to the at least one of the plurality of connectors; and
controlling the isolator circuit to reconnect power to the at least one of the plurality of connectors from the electrical system.

9. The method of claim 8, wherein the work machine is a paving machine, and wherein controlling the isolator circuit to terminate power to at least one of the plurality of connectors comprises controlling the isolator circuit to terminate power to a first plurality of connectors of the plurality of connectors, the first plurality of connectors positioned on a tractor portion of the paving machine.

10. The method of claim 9, wherein the paving machine further comprises a screed portion, wherein the plurality of connectors further comprise a second plurality of connectors positioned on the screed portion, and wherein the method further comprises:
controlling the isolator circuit to terminate power to at least one of the second plurality of connectors from the electrical system of the work machine;
changing a connected state of at least one component with respect to the at least one of the second plurality of connectors; and
controlling the isolator circuit to reconnect power to the at least one of the second plurality of connectors from the electrical system.

11. The method of claim 9, wherein the paving machine further comprises a screed portion, wherein the plurality of connectors further comprise a second plurality of connectors positioned on the screed portion, and wherein the isolator circuit is a first isolator circuit, and wherein the method further comprises:
controlling a second isolator circuit to terminate power to at least one of the second plurality of connectors from the electrical system of the work machine;
changing a connected state of at least one component with respect to the at least one of the second plurality of connectors; and
controlling the second isolator circuit to reconnect power to the at least one of the second plurality of connectors from the electrical system.

12. The method of claim 10, wherein the at least one component comprises first components connectable to the first plurality of connectors and second components connectable to the second plurality of connectors wherein the first components comprise at least one of an auger height sensor or a conveyor height sensor, and wherein the second components comprise at least one of a grade sensor, a height sensor, or a pendant control.

13. The method of claim 8, wherein the work machine is a cold planer machine, and wherein the at least one component comprises at least one of a grade sensor or a pendant control.

14. An electrical system of a work machine, the electrical system comprising:
a machine electrical system connected to receive power from a power source of the work machine;
a plurality of connectors for electrically connecting and disconnecting detachable components to the work machine, the plurality of connectors configured to receive power from the machine electrical system; and
an isolator circuit connected between at least one of the plurality of connectors and the machine electrical system to selectively terminate power to the at least one of the plurality of connectors while the power source is providing power to the machine electrical system.

15. The electrical system of claim 14, wherein the work machine is a paving machine, and wherein the machine electrical system and power source are positioned on a tractor portion of the paving machine, and wherein the plurality of connectors comprise a first plurality of connectors positioned on the tractor portion.

16. The electrical system of claim 15, wherein the paving machine further comprises a screed portion, and wherein the plurality of connectors further comprise a second plurality of connectors positioned on the screed portion.

17. The electrical system of claim 16, wherein the isolator circuit is a first isolator circuit and the at least one of the plurality of connectors is at least one of the first plurality of connectors, and wherein electrical system further comprises:
a second isolator circuit connected between the electrical system and at least one of the second plurality of connectors.

18. The electrical system of claim 17, wherein the first components comprise at least one of an auger height sensor or a conveyor height sensor, and wherein the second components comprise at least one of a grade sensor, a height sensor, or a pendant control.

19. The electrical system of claim 15, wherein the isolator circuit comprises a plurality of isolator circuits, each connected between a respective one of the plurality of connectors and the electrical system.
